(19) United States
(12) Patent Application Publication
(10) Pub. No.: US 2016/0182638 A1
(43) Pub. Date: Jun. 23, 2016

(54) CLOUD SERVING SYSTEM AND CLOUD SERVING METHOD

(71) Applicant: Tianjin Surdoc Corp., Tianjin (CN)

(72) Inventors: Youbing JIN, Tianjin (CN); Donglin WANG, Tianjin (CN)

(21) Appl. No.: 15/055,373

(22) Filed: Feb. 26, 2016

Related U.S. Application Data
(63) Continuation of application No. PCT/CN2014/085218, filed on Aug. 26, 2014.
Application No. PCT/CN2014/085218 is a continuation-in-part of application No. 13/858,489, filed on Apr. 8, 2013.
Application No. 13/858,489 is a continuation-in-part of application No. 13/271,165, filed on Oct. 11, 2011, now Pat. No. 9,176,953.
Application No. 13/271,165 is a continuation of application No. PCT/CN2012/075841, filed on May 22, 2012.
Application No. PCT/CN2012/075841 is a continuation of application No. PCT/CN2012/076516, filed on Jun. 6, 2012.
(60) Provisional application No. 61/621,553, filed on Apr. 8, 2012.

(30) Foreign Application Priority Data
May 12, 2012 (CN) 201210132926.7
May 16, 2012 (CN) 201210151984.4
Aug. 26, 2013 (CN) 201310376041.6
Aug. 26, 2014 (CN) 201410422496.1

(51) Int. Cl. H04L 29/08

(52) U.S. Cl. CPC H04L 67/1097; H04L 67/125; H04L 67/32; H04L 67/1095; H04L 67/1002

(57) ABSTRACT

A data storage system comprises at least one subsystem. Each subsystem includes at least two physical servers and at least two storage devices. Each physical server is connected to at least one storage device through a direct channel, and a part of storage medium in each storage device are used as a master storage area, another part of the storage medium in each storage device are used as a slave storage area. When data is written to the data storage system, the data is written to the master storage area of a certain storage device connected to a certain physical server in a certain subsystem, and is synchronized to the slave storage area of another storage device connected to anther physical server. A corresponding cloud serving method is disclosed.

### CROSS-REFERENCE TO RELATED APPLICATIONS

The present application is a continuation of International Patent Application No. PCT/CN2014/085218 filed on Aug. 26, 2014, which claims priority of Chinese Patent Application No. 201310376041.6 filed on Aug. 26, 2013 and Chinese Patent Application No. 201410422496.1 filed on Aug. 26, 2014, and is also a continuation-in-part of U.S. patent application Ser. No. 13/858,489 filed on Apr. 8, 2013, which is a continuation of PCT/CN2012/075841 filed on May 22, 2012 claiming priority of Chinese patent application 201210132926.7 filed on May 2, 2012, which is also a continuation of PCT/CN2012/076516 filed on Jun. 6, 2012 claiming priority of Chinese patent application 201210151984.4 filed on May 16, 2012, which claims priority to U.S. Provisional Patent Application No. 61,621,553 filed on Apr. 8, 2012, and which is continuation-in-part of U.S. patent application Ser. No. 13/271,165 filed on Oct. 11, 2011, the contents of which are incorporated herein by reference.

### TECHNICAL FIELD

Aspects of the present invention relate to cloud serving technology, and more particularly to a cloud storage system and a cloud storage method.

### BACKGROUND

Mass data storage is often employed in cloud services. FIG. 1 illustrates a cloud serving system according to the prior art. As shown in FIG. 1, mass data storage according to the prior art is usually performed with SAN and fabric switches, resulting in high costs. Some cloud storage technology such as Hadoop uses a large number of low-cost servers to form massive storage capacity, which reduces costs compared with the technology using SAN. However, a corresponding storage server is required for each storage device, expensive network devices are required due to high requirements for network bandwidth. Furthermore, risks due to single point failure still exist. Therefore, costs, performances and reliability of cloud serving technology is required to be further improved.

In view of this, a cloud serving architecture capable of storing mass data with high performances and low costs is needed.

### SUMMARY

Embodiments of the present invention are directed to a cloud serving system and a cloud serving method which provide a mass data storage architecture with high performances, low costs and high reliability.

According to an embodiment of the present invention, a data storage system comprises at least one subsystem. Each subsystem includes at least two physical servers and at least two storage devices. Each physical server is connected to at least one storage device through a direct channel, and a part of storage medium in each storage device are used as a master storage area, another part of the storage medium in each storage device are used as a slave storage area. When data is written to the data storage system, the data is written to the master storage area of a certain storage device connected to a certain physical server in a certain subsystem, and is synchronized to the slave storage area of another storage device connected to anther physical server.

According to another embodiment of the present invention, a cloud serving method for a data storage system comprising at least one subsystem each of which includes at least two physical servers and at least two storage devices comprises: connecting each physical server to at least one storage device through a direct channel; dividing each storage device into a master storage area and a slave storage area; and when data is written to the data storage system, writing the data to the master storage area of a certain storage device connected to a certain physical server in a certain subsystem, and synchronizing the data to the slave storage area of another storage device connected to anther physical server.

With the cloud serving system and the cloud serving method according to embodiments of the present invention, the data communications are performed only via direct connection between the physical servers and the storage devices. Furthermore, since all data is stored in duplicate automatically, if a physical server or a storage device connected to the physical server fails, the same data can be accessed through another physical server.

### BRIEF DESCRIPTION OF DRAWINGS

FIG. 1 is a block diagram schematically illustrating a cloud storage system according to the prior art.

FIG. 2 is a block diagram schematically illustrating a cloud storage system according to an embodiment of the present invention.

FIG. 3 is a block diagram schematically illustrating a cloud storage system according to another embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The accompanying drawings and the following embodiments, the present invention will be described in further detail. It should be understood that the specific embodiments described herein are merely examples for explaining the present invention and are not intended to limit the present invention.

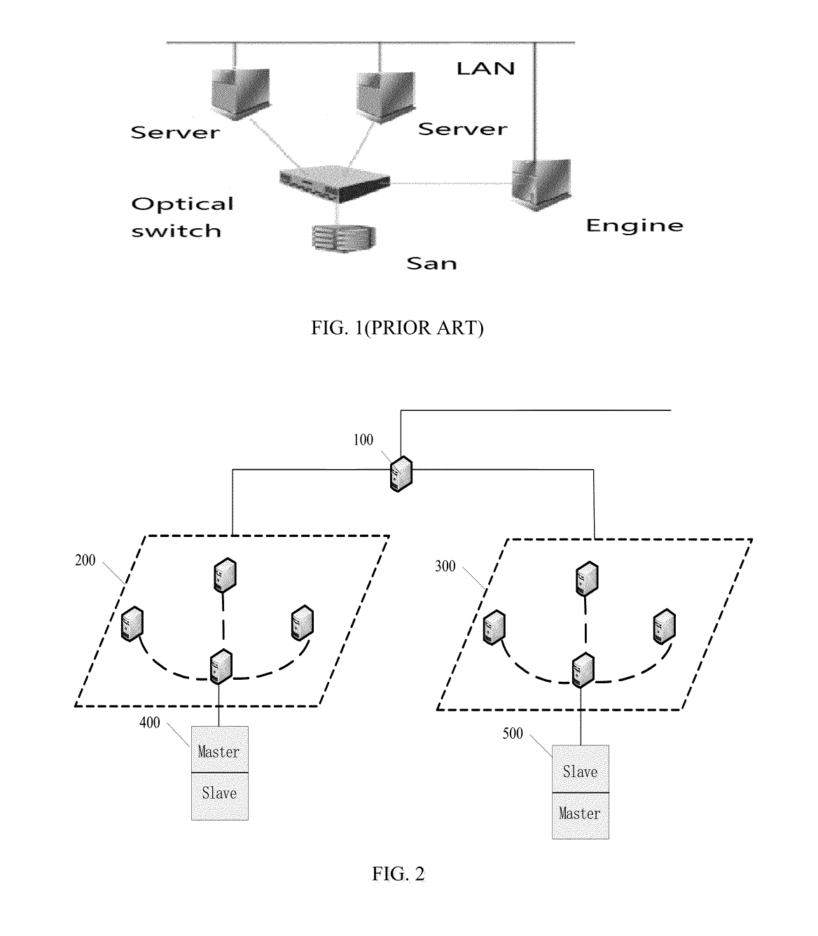

FIG. 2 is a block diagram schematically illustrating a cloud serving subsystem according to an embodiment of the present invention. As shown in FIG. 2, in an embodiment, a cloud serving subsystem includes two physical servers 200 and 300 and two storage devices 400 and 500 connected to the physical servers 200 and 300 respectively. Each of the two storage devices 400 and 500 includes a master storage area and a slave storage area. The master storage area of one of the two storage devices 400 and 500 and the slave storage area of the other of the two storage devices 400 and 500 form a group. In detail, the master storage area of the storage device 400 and the slave storage area of the storage device 500 form a group, meanwhile the master storage area of the storage device 500 and the slave storage area of the storage device 400 form another group.

The cloud serving subsystem further includes a scheduling server 100 for coordinating loads of the two physical servers 200 and 300.

Under normal circumstances, when a service is scheduled to the server 200 so that a data writing operation is to be performed in the server 200, data is directly written to the master storage area of the storage device 400, and the data written into the master storage area of the storage device 400 is synchronized to the slave storage area of the storage device 500. Similarly, when a service is scheduled to the server 300 so that a data writing operation is to be performed in the server 300, data is directly written to the master storage area of the storage device 500, and the data written into the master storage area of the storage device 500 is synchronized to the slave storage area of the storage device 400.

When a service is scheduled to the server 200 so that a data reading operation is to be performed in the server 200, data can be read directly from the storage device 400 no matter the data is stored in the master storage area or in the slave storage area. Here, the data stored in the slave storage area of the storage device 400 is the same as that stored in the master storage area of the storage device 500. When the data is accessed through the server 200, even though the data is stored in the master storage area of the storage device 500, the server 200 will access the data stored in the slave storage device 400, rather than the data stored in the master storage area of the storage device 500, via a directly connected interface, such as an SAS channel, according to the strategy of data reading and writing based on proximity. Similarly, when a service is scheduled to the server 300 so that a data reading operation is to be performed in the server 300, data can be read directly from the storage device 500 no matter the data is stored in the master storage area or in the slave storage area.

If any one of the physical server 200 and the storage device 400 fails due to, e.g., damage, the follow-up services will be scheduled to the physical server 300 which will then provide service to the users. Since the storage device 500 stores all of the data, all of the data can be accessed through interaction between the physical server 300 and the storage device 500. In addition, as one storage device corresponds to only one physical server, data accessing conflict will not occur. After the fault device is recovered, e.g. repaired or replaced, and put into operation again, all data written to the storage device 500 during the period when the physical server 200 or the storage device 400 fails will be synchronized to the storage device 400 so that the storage devices 400 and 500 still have the same data. Similarly, if any one of the physical server 300 and the storage device 500 fails, the follow-up services will be scheduled to the physical server 200, and all data written to the storage device 400 during the period when the physical server 300 or the storage device 500 fails will be synchronized to the storage device 500 after the failure is recovered.

In one embodiment of the present invention, each physical server runs multiple virtual machines. Under normal circumstances, both of the physical servers 200 and 300 provide services to the users, and run the same virtual machines. A secondary level load balancing server coordinates virtual machine loads of the two physical servers 200 and 300. The scheduling may be performed according to the strategy based on proximity, e.g., directly connected channel having priority to access data, or the strategy based on polling, or the strategy based on low load priority scheduling, or any combinations thereof.

In one embodiment of the present invention, each physical server includes at least one virtual machine having a storage sharing function, so that the other virtual machines of the same physical server can access the storage device via the virtual machines having the storage sharing function. In this way, it is prevented that multiple virtual machines simultaneously access to the same storage device, thereby ensuring system reliability and data consistency.

In one embodiment of the present invention, each of the physical servers 200 and 300 includes at least one virtual machine having a storage sharing function, so that failure of any one of the servers 200 and 300 will not affect the load balancing service.

In one embodiment of the present invention, each of the physical servers 200 and 300 includes a plurality of virtual machines having a same function. In this case, the secondary level load balancing service can be scheduled among the plurality of virtual machines, thereby increasing the load capacity of the system.

In one embodiment of the present invention, each of the physical servers 200 and 300 further includes at least one virtual machine for providing real-time services, such as Web services and at least one virtual machine providing non-real-time services, such as conversion and indexes. When the physical server 200 fails, in addition to directing the services to the physical server 300, at least one virtual machine providing non-real-time services in the server 300 can be stopped temporarily or transferred to other servers, meanwhile at least one virtual machine providing real-time services can be added in the server 300, so that the load capacity for providing real-time services to users is less or substantially not affected due to failure of hardware.

In one embodiment of the present invention, the master storage area and the salve storage area have even roles. That is, data can be written to the master storage area of a certain storage device and then synchronized to the slave storage area of another storage device. Alternatively, data can be written to the slave storage area of a certain storage device and then synchronized to the master storage area of another storage device.

In one embodiment of the present invention, a software is used to ensure that the data stored in the master storage area of the storage device 400 and the data stored in the salve storage area of the storage device 500 are strictly identical, and that the data stored in the master storage area of the storage device 500 and the data stored in the salve storage area of the storage device 500 are strictly identical. In one embodiment, the data is stored in the form of disk file. In this case, in order to ensure the above-mentioned uniformity, a distributed file system, e.g., a two-copy mode of GlusterFS, or a file synchronization mode of DRBD is employed.

In the case of the two-copy mode of GlusterFS being employed, two copies are generated when a writing operation for a document is performed in the server 200. One copy of the document is stored in the master storage area of the storage device 400 via a manner of direct connection, and the other copy of the document is stored in the slave storage area of the storage device 500 through network access.

In the case of the file synchronization mode of DRBD is employed, when a writing operation is performed for a document in the server 200, firstly the document is stored in the master storage area of the storage device 400 via a manner of direct connection, and then the data stored in the master storage area of the storage device 400 is copied to the slave storage area of the storage device 500 synchronically or asynchronously.

In one embodiment of the present invention, the storage devices 400 and 500 may be DAS storage devices. In this case, each physical server is connected to the corresponding DAS storage device through a direct channel, e.g., SAS or SATA, the physical server can access both data stored in the master storage area and that stored in the slave storage area through the direct channel at any time, thereby implementing high speed data reading and writing. In this way, not only high reliability can be realized due to two copies of data, but also high performances can be realized due to usage of the direct channel. By using the master-slave relationship, the data stored in the directly connected storage area is copied and one copy can be used if the other copy cannot be accessed.

In one embodiment of the present invention, each of the storage devices 400 and 500 has a plurality of storage media such as magnetic disks, SSD disks or magnetic tapes. Some of the storage media will form the master storage area while another storage media will form the slave storage area.

In one embodiment of the present invention, in order to improve reliability, a redundant storage mode, such as RAID or erasure codes, is used in the master storage area and/or the slave storage area. In this way, when one or more than one storage media fail, the other storage media can be operated normally, so the system can be operated normally without need to switching to other services or other storage devices, which improves the reliability of the system.

In one embodiment of the present invention, each subsystem includes three or more physical servers, so there are three or more copies of data. The structure and operation of such a subsystem is similar to the above-mentioned subsystem including two physical servers, and repeated description will be omitted herein.

In one embodiment of the present invention, each physical server has at least one virtual IP. When this physical server fails, the same virtual IP is activated by another physical server to automatically take over the user requests which should be handled by the failed physical server.

In the above embodiments, multiple devices form a high availability architecture in which one device can replace another failed device to continue to provide services. Meanwhile, no additional costs are required for the high availability architecture since multiple devices can provide services at the same time, while the standby device is idle when the master device is in good condition according to a conventional high availability architecture.

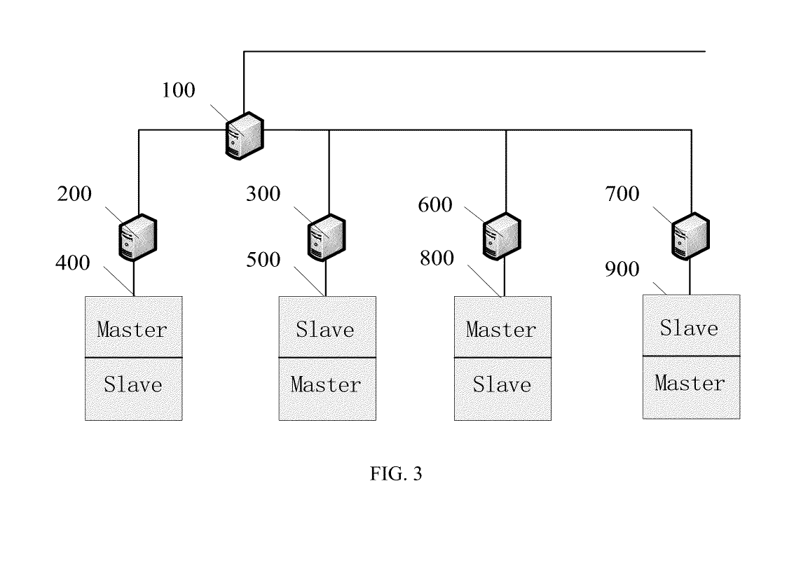

When the amount of data increases, it is required to expand the cloud serving system. As shown in FIG. 3, there are two cloud serving subsystems. In detail, the added physical servers 600 and 700 as well as the storage devices 800 and 900 form a second cloud serving subsystem. The operation of the second cloud serving subsystem is substantially the same as the cloud serving subsystem described with reference to FIG. 2 and repeated description will be omitted herein. Those skilled in the art can appreciate that the cloud serving system can be expanded in a similar manner to include more subsystems.

When a service is scheduled to a virtual machine in the physical server 200 and a data writing operation is demanded, the virtual machine in the physical server 200 can access the data with high speed by using a direct channel if the data is stored in the storage device 400. However, if the data is stored in the storage device 800 or 900, an across-subsystem data reading will be performed, thus the virtual machine in the physical server 200 reads the data through a network channel.

As can be seen, in the cloud serving system according to embodiments of the present invention, when a user uploads and downloads data of the user, most of the data is stored in a storage device corresponding to the local physical server, and a high-speed direct channel is used to implement data reading and writing operations. Only for a small amount of operations such as sharing, the across-subsystem data operations using a network channel are required.

In one embodiment of the present invention, the scheduling server 100 employs the scheduling strategy based on data, that is, an operation request for data stored in a certain subsystem will be scheduled to that subsystem, so as to realize more effective data reading and writing performances compared with conventional scheduling strategies, such as based on polling or load. In addition, a combination of the scheduling strategy based on data and other scheduling strategies, such as based on polling or load, can be used. In this case, it is preferred that the scheduling strategy based on data has priority.

In one embodiment of the present invention, all data of a particular user is stored in a same subsystem as much as possible, and services requested by the user are performed by the subsystem as much as possible, so as to realize the scheduling strategy based on data.

In one embodiment of the present invention, the scheduling server 100 employs the scheduling strategy based user, that is, a default subsystem is set for each user, an operation request requested by a certain user will be scheduled to the default subsystem, so as to realize the object of storing all data of a particular user in the same subsystem, compared with conventional scheduling strategies, such as based on polling or load. In addition, a combination of the scheduling strategy based on user and other scheduling strategies can be used. In this case, it is preferred that the scheduling strategy based on user has priority.

In one embodiment of the present invention, each subsystem includes its own secondary level load balancing server for scheduling service requests for the subsystem to a plurality of application virtual machines or a plurality of processes. The scheduling strategy can be based on polling or load.

In one embodiment of the present invention, the function of the above-mentioned secondary level load balancing server is integrated into the scheduling server 100. That is, the scheduling server 100 can directly schedule services requested by a user to a certain physical server or a certain virtual machine or a certain progress of a certain subsystem.

In one embodiment of the present invention, the scheduling server 100 includes at least two physical servers, and each physical server can independently undertake all load balancing features to ensure that any one device failure will not cause the system to stop working.

With the cloud serving systems according to embodiments of the present invention, the flow of the network channels in a system can be reduced greatly, and the direct channel is exclusive for one physical server. In a practical architecture, a large capacity storage system can be constructed with only ordinary Gigabit Ethernet, without requirements for a fiber-optic network such as SAN. In this way, the storage costs are reduced greatly, and performances of the system are improved. In addition, high reliability of the system can be ensured by using the load scheduling server.

In one embodiment of the present invention, in order to ensure high reliability of the secondary level load balancing server, at least two secondary level load balancing servers which are operated simultaneously can be disposed. The at least two secondary level load balancing servers can be disposed in servers outside the subsystems, or in two or more physical servers inside the subsystems. The at least two secondary level load balancing servers can be copies of each other. The at least two secondary level load balancing servers monitor each other through physical or virtual heartbeat lines. When a secondary level load balancing server fails, another one can take over it automatically.

In one embodiment of the present invention, a subsystem includes three or more physical servers and corresponding storage devices. In addition to the case that every two physical servers and corresponding storage devices form a cloud storage subsystem, the following manner can be used. In detail, as shown in FIG. 3, the data written through the server 200 is stored in the master storage area of the storage device 400, the data written through the server 300 is stored in the master storage area of the storage device 500 and the slave storage area of the storage device 800, the data written through the server 600 is stored in the master storage area of the storage device 800 and the salve storage area of the storage device 900. Alternatively, the data written through the server 200 can be distributed to different storage devices.

In one embodiment of the present invention, when there are a plurality of groups of physical servers and corresponding storage devices, the scheduler server 100 acts as performing the first level load balancing scheduling according to a strategy based on proximity. That is, the physical servers are appointed for the service requests according to a strategy of “data accessing through direct channels has priority and then network data accessing”. Once the physical server is determined, a second level load balancing virtual machine in the physical sever implements secondary level load balancing scheduling according to a strategy based on load. For example, the service requests are appointed to one of the plurality of application virtual machines in the physical server, and the appointed virtual machine will access a corresponding storage device.

Embodiments of the present invention further provide a cloud serving method for a cloud storage system comprising at least two physical servers and at least two storage devices. The method comprises:

connecting each physical server with one storage device through a direct channel;

dividing each storage device into a master storage area and a slave storage area; and

when a data writing operation is performed in one physical server, writing a document to the master storage area of the storage device connected to the physical sever, and synchronize the document to the slave storage area of the storage device connected to another physical server.

In one embodiment of the present invention, the scheduling strategy based on data is used to realize load balancing among the multiple physical servers. Each physical server has a plurality of virtual machines, and has its own secondary level load balancing server which employs the scheduling strategy based on load.

Those skilled in the art will appreciate that the above technical schemes described with reference to the cloud serving system can be applied to the cloud serving method similarly.

Those skilled in the art will also appreciate that the above technical schemes described in embodiments can be combined to form new cloud serving systems and new cloud serving methods, all of which are falling into the scope of this application.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A data storage system, comprising at least one subsystem, each subsystem including at least two physical servers and at least two storage devices,
wherein each physical server is connected to at least one storage device through a direct channel, and a part of storage medium in each storage device are used as a master storage area, another part of the storage medium in each storage device are used as a slave storage area,
wherein when data is written to the data storage system, the data is written to the master storage area of a certain storage device connected to a certain physical server in a certain subsystem, and is synchronized to the slave storage area of another storage device connected to anther physical server.

2. The system of claim 1, wherein when data is read from the data storage system, the data is read from the physical server connected to the storage device in which the data is stored.

3. The system of claim 1, further comprising a scheduling server for scheduling a user request to a certain subsystem or a certain physical server.

4. The system of claim 3, wherein the scheduling server employs a scheduling strategy based on proximity.

5. The system of claim 3, wherein at least two scheduling servers are included, when one scheduling server fails, the user requests are scheduled by another scheduling server.

6. The system of claim 3, wherein each physical server includes a plurality of application virtual machines; when one physical server is selected to implement a user request, one virtual machine in the physical server implements the user request; and when one subsystem is selected to implement a user request, one virtual machine in a certain physical server of the subsystem implements the user request.

7. The system of claim 6, wherein at least one physical server of each subsystem further comprises a secondary level load balancing virtual machine for scheduling the user request to one of the application virtual machines.

8. The system of claim 7, wherein the secondary level load balancing virtual machine employs a scheduling strategy based on polling or load.

9. The system of claim 6, wherein each physical server further comprises a virtual machine having a storage sharing function, other virtual machines in the same physical server access the storage device connected to the physical server through the virtual machine having the storage sharing function.

10. The system of claim 1, wherein a multi-copy mode of a distribute file system GlusterFS or a file synchronization mode of DRBD is used to synchronize the data from the master storage area of a certain storage device to the slave storage area of another storage device connected to anther physical server.

11. The system of claim 4, wherein a default subsystem is set for each user, the user requests from a certain user are sent to the default subsystem of the user by the scheduling server.

12. The system of claim 1, wherein when a certain storage device or the physical server connected to the storage device fails, operations for user data affected by the failure are automatically switched to another physical server connected to the storage device storing the same user data.

13. The system of claim 12, wherein each physical server has at least one virtual IP, when a certain physical server fails, another physical server activates the virtual IP.

14. The system of claim 12, wherein each physical server includes at least one virtual machine for providing non-real-time services, and when the physical server fails, the at least one virtual machine providing non-real-time services is stopped temporarily or transferred to other servers, at least one virtual machine providing real-time services is added in the server.

15. The system of claim 1, wherein the storage device is DAS, each physical server and the corresponding storage device access the data through an SAS channel.

16. A cloud serving method for a data storage system comprising at least one subsystem, each subsystem including at least two physical servers and at least two storage devices, the method comprising:
connecting each physical server to at least one storage device through a direct channel;
dividing each storage device into a master storage area and a slave storage area; and
when data is written to the data storage system, writing the data to the master storage area of a certain storage device connected to a certain physical server in a certain subsystem, and synchronizing the data to the slave storage area of another storage device connected to anther physical server.
